(19) United States
(12) Patent Application Publication
(10) Pub. No.: US 2009/0240559 A1
(43) Pub. Date: Sep. 24, 2009

(54) Competitor Offering Analysis for Product Catalogs

(76) Inventor: Sima Nadler, Kochav Yair (IL)

Correspondence Address: IBM CORPORATION, T.J. WATSON RESEARCH CENTER, P.O. BOX 218, YORKTOWN HEIGHTS, NY, 10598, US

(21) Appl. No.: 12/053,633

(22) Filed: Mar. 24, 2008

(51) Int. Cl. G06Q 10/00

(52) U.S. Cl. 705/10

(57) ABSTRACT

An automated competitor offering analysis system including a competitor offer compiler configured to retrieve at least one competitor offering from a source of competitor offerings, identify any of the competitor offerings that correspond to any offering in a set of monitored offerings, and create a set of competitor offerings including any of the corresponding offerings, and a monitor engine configured to compare any of the offerings in the set of monitored offerings to any of the corresponding offerings in the set of competitor offerings, and calculate at least one score for the compared offering in the set of monitored offerings in accordance with at least one predefined scoring function, where the score indicates the competitiveness of the compared monitored offering with respect to the compared competitor offering.

### FIELD OF THE INVENTION

The present invention relates to computer-based product catalog systems in general, and more particularly to automated analysis thereof.

### BACKGROUND OF THE INVENTION

In order to maintain competitiveness, it typically falls to one or more individuals within a company to manually monitor the products and services (hereinafter collectively referred to as “offerings”) of its competitors and compare their attributes, such as features, rate plans, and prices, with those of the company's offerings. For companies with large numbers of offerings and/or complex offerings, this is a time-consuming and expensive task.

It is increasingly common for companies to present their offerings and their attributes via a computer-based catalog. Software for managing such catalogs is sold by many different vendors, such as IBM, SAP, Oracle, and others. Unfortunately, such product catalog software does not include functionality for automatically comparing a company's offerings to those of its competitors.

### SUMMARY OF THE INVENTION

The present invention in embodiments thereof provides for automated competitor offering analysis for offerings in a company's product catalog.

In one aspect of the present invention an automated competitor offering analysis system is provided including a competitor offer compiler configured to retrieve at least one competitor offering from a source of competitor offerings, identify any of the competitor offerings that correspond to any offering in a set of monitored offerings, and create a set of competitor offerings including any of the corresponding offerings, and a monitor engine configured to compare any of the offerings in the set of monitored offerings to any of the corresponding offerings in the set of competitor offerings, and calculate at least one score for the compared offering in the set of monitored offerings in accordance with at least one predefined scoring function, where the score indicates the competitiveness of the compared monitored offering with respect to the compared competitor offering.

In another aspect of the present invention the source of competitor offerings includes any of competitor web sites, catalogs, and virtual worlds.

In another aspect of the present invention further includes a management interface configured to create the set of monitored offerings.

In another aspect of the present invention the management interface is configured to allow any attribute of any of the monitored offerings to be selected for monitoring.

In another aspect of the present invention the monitor engine is configured to calculate the score for any of a) an attribute of any of the monitored offerings, b) a group of attributes of any of the monitored offerings, and c) any of the monitored offerings as a whole.

In another aspect of the present invention the monitor engine is configured to provide a notification regarding any of the monitored offerings in accordance with predefined notification criteria.

In another aspect of the present invention the predefined notification criteria are met when the score of any of the monitored offerings crosses a predefined threshold.

In another aspect of the present invention the monitor engine is configured to set an indicator associated with any of the monitored offerings within a catalog to indicate a level of competitiveness associated with any aspect of the offering.

In another aspect of the present invention any of the competitor offer compiler and the monitor engine are implemented in any of a) computer hardware and b) computer software embodied in a computer-readable medium.

In another aspect of the present invention an automated competitor offering analysis method is provided including retrieving at least one competitor offering from a source of competitor offerings, identifying any of the competitor offerings that correspond to any offering in a set of monitored offerings, creating a set of competitor offerings including any of the corresponding offerings, comparing any of the offerings in the set of monitored offerings to any of the corresponding offerings in the set of competitor offerings, and calculating at least one score for the compared offering in the set of monitored offerings in accordance with at least one predefined scoring function, where the score indicates the competitiveness of the compared monitored offering with respect to the compared competitor offering.

In another aspect of the present invention the retrieving step includes retrieving from any of competitor web sites, catalogs, and virtual worlds.

In another aspect of the present invention further includes selecting any attribute of any of the monitored offerings to be selected for monitoring.

In another aspect of the present invention the calculating step includes calculating the score for any of a) an attribute of any of the monitored offerings, b) a group of attributes of any of the monitored offerings, and c) any of the monitored offerings as a whole.

In another aspect of the present invention further includes providing a notification regarding any of the monitored offerings in accordance with predefined notification criteria.

In another aspect of the present invention the providing step includes providing the notification when the score of any of the monitored offerings crosses a predefined threshold.

In another aspect of the present invention further includes setting an indicator associated with any of the monitored offerings within a catalog to indicate a level of competitiveness associated with any aspect of the offering.

In another aspect of the present invention a computer program is provided embodied on a computer-readable medium, the computer program including a code segment operative to retrieve at least one competitor offering from a source of competitor offerings, a code segment operative to identify any of the competitor offerings that correspond to any offering in a set of monitored offerings, a code segment operative to create a set of competitor offerings including any of the corresponding offerings, a code segment operative to compare any of the offerings in the set of monitored offerings to any of the corresponding offerings in the set of competitor offerings, and a code segment operative to calculate at least one score for the compared offering in the set of monitored offerings in accordance with at least one predefined scoring function, where the score indicates the competitiveness of the compared monitored offering with respect to the compared competitor offering.

In another aspect of the present invention the code segment operative to retrieve is operative to retrieve from any of competitor web sites, catalogs, and virtual worlds.

In another aspect of the present invention the computer program further includes a code segment operative to select any attribute of any of the monitored offerings to be selected for monitoring.

In another aspect of the present invention the code segment operative to calculate is operative to calculate the score for any of a) an attribute of any of the monitored offerings, b) a group of attributes of any of the monitored offerings, and c) any of the monitored offerings as a whole.

In another aspect of the present invention the computer program further includes a code segment operative to provide a notification regarding any of the monitored offerings in accordance with predefined notification criteria.

In another aspect of the present invention the code segment operative to provide is operative to provide the notification when the score of any of the monitored offerings crosses a predefined threshold.

In another aspect of the present invention the computer program further includes a code segment operative to set an indicator associated with any of the monitored offerings within a catalog to indicate a level of competitiveness associated with any aspect of the offering.

### BRIEF DESCRIPTION OF THE DRAWINGS

The present invention will be understood and appreciated more fully from the following detailed description taken in conjunction with the appended drawings in which:

FIG. 1 is a simplified conceptual illustration of an automated competitor offering analysis system, constructed and operative in accordance with an embodiment of the present invention; and

FIG. 2 is a simplified flowchart illustration of an exemplary method of operation of the system of FIG. 1, operative in accordance with an embodiment of the present invention.

### DETAILED DESCRIPTION OF THE INVENTION

The present invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

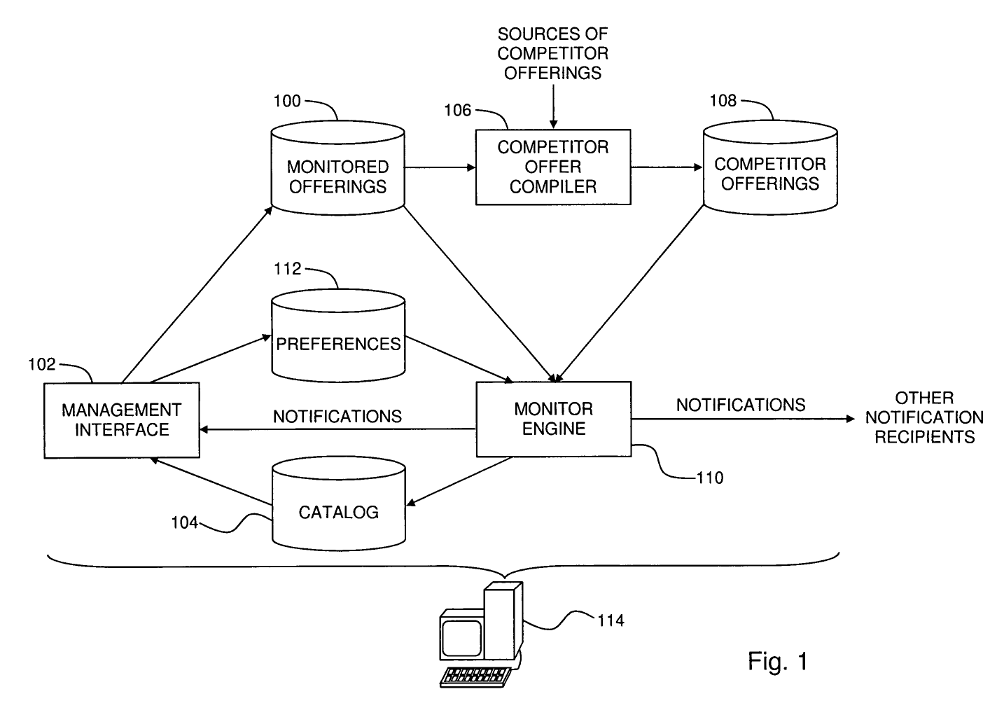

Reference is now made to FIG. 1, which is a simplified conceptual illustration of an automated competitor offering analysis system, constructed and operative in accordance with an embodiment of the present invention. In the system of FIG. 1 a set of monitored offerings 100 is created, such as where a management interface 102 is used to select one or more offerings from a catalog 104, and optionally one or more attributes of each selected offering. A competitor offer compiler 106 creates a set of competitor offerings 108 by retrieving competitor offerings from one or more sources of competitor offerings, such as competitor web sites, catalogs, virtual worlds, etc., identifying, using any known comparison technique, competitor offerings that correspond to any of the offerings in the set of monitored offerings 100, and storing the corresponding offerings in set 108, preferably together with an identifier associating each competitor offering in set 108 with the monitored offering in set 100 to which it corresponds. Competitor offer compiler 106 preferably updates the set of competitor offerings 108 periodically. A monitor engine 110 periodically compares the offerings in the set of monitored offerings 100 to their corresponding offerings in the set of competitor offerings 108 and calculates one or more scores for each offering in the set of monitored offerings 100 in accordance with one or more predefined scoring functions. In various embodiments, a score is calculated for a single attribute, such as price, for a group of attributes, such as price, shipping time, and length of warranty, and/or for the offering as a whole. The scoring functions may be defined such that a higher score indicates that an offering is more competitive than a competitor's offering, while a lower score indicates that an offering is less competitive, or vice versa. Monitor engine 110 preferably provides a notification to management interface 102 and/or other predefined notification recipients regarding an offering's competitiveness score in accordance with predefined notification criteria, such as when a score crosses a predefined threshold between competitiveness and non-competitiveness. Additionally or alternatively, monitor engine 110 sets indicators within catalog 104 to indicate the competitiveness of each offering, attribute, and/or attribute group. For example, a green light icon may be provided for display together with an offering in catalog 104 to indicate that a score has achieved a predefined level of competitiveness, while a red light icon may be used to indicate otherwise.

Any of the predefined information described herein may be defined using management interface 102 and preconfigured with monitor engine 110 and/or stored in a set of preferences 112 for use by monitor engine 110.

Any of the elements shown in FIG. 1 are executed by or otherwise accessible to a computer 114, such as by implementing any of the elements shown in FIG. 1 in computer hardware and/or in computer software embodied in a computer-readable medium in accordance with conventional techniques.

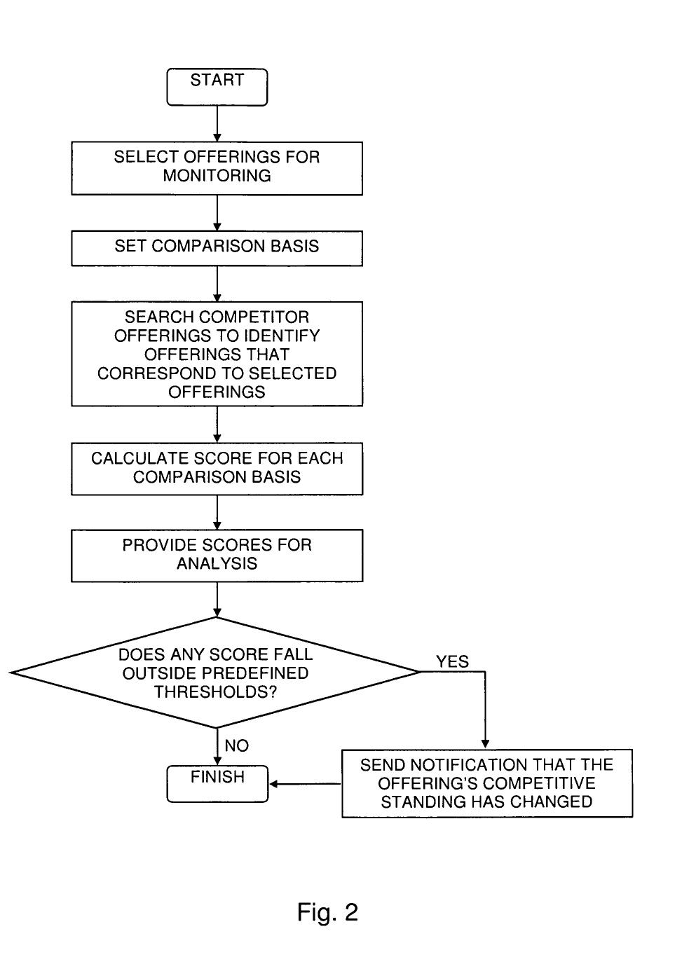

Reference is now made to FIG. 2, which is a simplified flowchart illustration of an exemplary method of operation of the system of FIG. 1, operative in accordance with an embodiment of the present invention. In the method of FIG. 2, one or more of a company's offerings are selected for monitoring and comparison with corresponding competitor offerings. The comparison basis is preferably set globally, as a default, and/or at the offering level to indicate whether competitiveness scores are to be calculated for all attributes of a selected offering, selected attributes, selected groups of attributes, and/or for the offering as a whole. Competitor offerings are searched using any known data gathering technique to identify, using any known comparison technique, competitor offerings that correspond to any of the selected offerings. A score is then calculated for each comparison basis in accordance with a predefined scoring function. Any of the scores are then made available for analysis, such as by providing a notification to predefined recipients in accordance with predefined notification criteria and/or by providing an indication of the score within a catalog together with the listing of the offering. For example, if any score falls outside of predefined thresholds, a notification may be sent to predefined recipients indicating that the offering's competitive standing has changed.

Besides the description of the present invention above, the present invention may be understood in the context of the following example where an offering selected for monitoring is a digital camera. In this example, the attributes of interest that are selected for monitoring include:
1) Price
2) Zoom range
3) Image Resolution
4) Physical camera size
   where the corresponding attribute values for the monitored offering are:
1) Price=$300
2) Zoom Range=×4
3) Image Resolution=8 MB
4) Physical camera size=ultrasmall (dimension=x,y,z).

Using the present invention a competitor's offering is found having the following attribute values:
1) Price=$350
2) Zoom Range=×3
3) Image Resolution=8 MB
4) Physical camera size=ultrasmall (dimension=x,y,z)

It may be seen that the monitored offering is more competitive than the competitor's offering in both price and zoom range attributes.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

What is claimed is:

1. An automated competitor offering analysis system comprising:
a competitor offer compiler configured to
retrieve at least one competitor offering from a source of competitor offerings,
identify any of said competitor offerings that correspond to any offering in a set of monitored offerings, and
create a set of competitor offerings including any of said corresponding offerings; and
a monitor engine configured to
compare any of said offerings in said set of monitored offerings to any of said corresponding offerings in said set of competitor offerings, and
calculate at least one score for said compared offering in said set of monitored offerings in accordance with at least one predefined scoring function, wherein said score indicates the competitiveness of said compared monitored offering with respect to said compared competitor offering.

2. A system according to claim 1 wherein said source of competitor offerings includes any of competitor web sites, catalogs, and virtual worlds.

3. A system according to claim 1 and further comprising a management interface configured to create said set of monitored offerings.

4. A system according to claim 3 wherein said management interface is configured to allow any attribute of any of said monitored offerings to be selected for monitoring.

5. A system according to claim 1 wherein said monitor engine is configured to calculate said score for any of a) an attribute of any of said monitored offerings, b) a group of attributes of any of said monitored offerings, and c) any of said monitored offerings as a whole.

6. A system according to claim 1 wherein said monitor engine is configured to provide a notification regarding any of said monitored offerings in accordance with predefined notification criteria.

7. A system according to claim 7 wherein said predefined notification criteria are met when said score of any of said monitored offerings crosses a predefined threshold.

8. A system according to claim 1 wherein said monitor engine is configured to set an indicator associated with any of said monitored offerings within a catalog to indicate a level of competitiveness associated with any aspect of said offering.

9. A system according to claim 1 wherein any of said competitor offer compiler and said monitor engine are implemented in any of a) computer hardware and b) computer software embodied in a computer-readable medium.

10. An automated competitor offering analysis method comprising:
retrieving at least one competitor offering from a source of competitor offerings;
identifying any of said competitor offerings that correspond to any offering in a set of monitored offerings;
creating a set of competitor offerings including any of said corresponding offerings;
comparing any of said offerings in said set of monitored offerings to any of said corresponding offerings in said set of competitor offerings; and
calculating at least one score for said compared offering in said set of monitored offerings in accordance with at least one predefined scoring function, wherein said score indicates the competitiveness of said compared monitored offering with respect to said compared competitor offering.

11. A method according to claim 10 wherein said retrieving step comprises retrieving from any of competitor web sites, catalogs, and virtual worlds.

12. A method according to claim 10 and further comprising selecting any attribute of any of said monitored offerings to be selected for monitoring.

13. A method according to claim 10 wherein said calculating step comprises calculating said score for any of a) an attribute of any of said monitored offerings, b) a group of attributes of any of said monitored offerings, and c) any of said monitored offerings as a whole.

14. A method according to claim 10 and further comprising providing a notification regarding any of said monitored offerings in accordance with predefined notification criteria.

15. A method according to claim 15 wherein said providing step comprises providing said notification when said score of any of said monitored offerings crosses a predefined threshold.

16. A method according to claim 10 and further comprising setting an indicator associated with any of said monitored offerings within a catalog to indicate a level of competitiveness associated with any aspect of said offering.

17. A computer program embodied on a computer-readable medium, the computer program comprising:
a code segment operative to retrieve at least one competitor offering from a source of competitor offerings;
a code segment operative to identify any of said competitor offerings that correspond to any offering in a set of monitored offerings;
a code segment operative to create a set of competitor offerings including any of said corresponding offerings;
a code segment operative to compare any of said offerings in said set of monitored offerings to any of said corresponding offerings in said set of competitor offerings; and
a code segment operative to calculate at least one score for said compared offering in said set of monitored offerings in accordance with at least one predefined scoring function, wherein said score indicates the competitiveness of said compared monitored offering with respect to said compared competitor offering.

18. A computer program according to claim 17 wherein said code segment operative to retrieve is operative to retrieve from any of competitor web sites, catalogs, and virtual worlds.

19. A computer program according to claim 17 and further comprising a code segment operative to select any attribute of any of said monitored offerings to be selected for monitoring.

20. A computer program according to claim 17 wherein said code segment operative to calculate is operative to calculate said score for any of a) an attribute of any of said monitored offerings, b) a group of attributes of any of said monitored offerings, and c) any of said monitored offerings as a whole.
